(19) United States
(12) Patent Application Publication
(10) Pub. No.: US 2013/0170185 A1
(43) Pub. Date: Jul. 4, 2013

(54) DISPLAY DEVICE WITH OPTICAL RECOGNITION OF INPUTTING INSTRUMENT

(71) Applicant: QIANG YOU, Shenzhen City (CN)

(72) Inventor: QIANG YOU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/433,295

(22) Filed: Mar. 29, 2012

(30) Foreign Application Priority Data
Dec. 28, 2011 (CN) 201110447330.1

(51) Int. Cl. G09F 13/04; F21V 7/00; F21V 21/00

(52) U.S. Cl. 362/97.1; 362/249.01; 362/235

(57) ABSTRACT

An exemplary display device includes a display panel, first light emitters, second light emitters, and light receivers. The first and second light emitters are uniformly disposed adjacent to a back surface of the display panel and are symmetrically arrayed respectively corresponding to two half portions of the back surface, and emit invisible light beams to pass through the display panel. The light beams emitted by the first light emitters are parallel and obliquely emitted towards the back surface along a first transmission direction. The light beams emitted by the second light emitters are parallel and obliquely emitted towards the back surface along a second transmission direction, and the first transmission direction is towards the second transmission direction. The light receivers are disposed corresponding to the first and second light emitters, and receive the light beams emitted by the first and second light emitters.

### BACKGROUND

1. Technical Field

The present disclosure generally relates to display devices, and particularly to a display device that can receive a user's input instructions via a display screen thereof.

2. Description of Related Art

Most touch display devices, such as capacitive touch display devices and resistive touch display devices, have a touch screen and need a direct touch from a stylus or the finger of a user for operation. However, after being used for a period of time, the surface of the touch screen is liable to become contaminated or damaged, and this may badly impact the operation of the touch display device.

What is needed, therefore, is a touch display device which can overcome the described limitations.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is an exploded, side plan view of a display device according to a first embodiment, wherein the display device includes an optical emitting device and an optical receiving device.

FIG. 2 is an isometric view of the optical emitting device of FIG. 1.

FIG. 3 is an exploded, side cross-sectional view of the display device of the first embodiment, showing essential optical paths when there is no directing object above a light-emitting surface of the display device to block light emitted from the light-emitting surface.

FIG. 4 is a circuit diagram of the optical receiving device of FIG. 1 and a signal processor of the display device.

FIG. 5 is similar to FIG. 3, but also showing a directing object above the light-emitting surface of the display device to block part of the light emitted from the light-emitting surface.

FIG. 6 is an exploded, side cross-sectional view of a display device according to a second embodiment.

FIG. 7 is an exploded, side plan view of a display device according to a third embodiment.

FIG. 8 is an exploded, side plan view of a display device according to a fourth embodiment.

FIG. 9 is an exploded, side cross-sectional view of a display device according to a fifth embodiment.

FIG. 10 is an exploded, side cross-sectional view of a display device according to a sixth embodiment.

### DETAILED DESCRIPTION

Reference will be made to the drawings to describe the embodiments in detail.

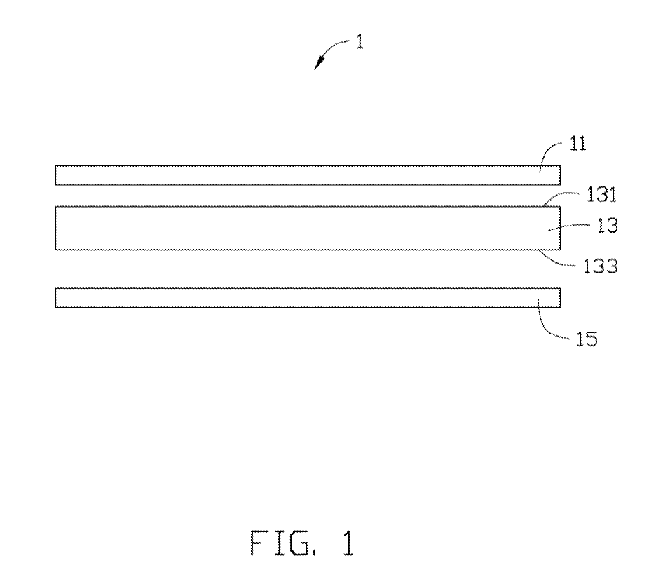

FIG. 1 is a schematic, side plan view of a display device 1 according to a first embodiment. In this embodiment, the display device 1 includes an optical emitting device 15, an optical receiving device 11, and a display panel 13. The optical emitting device 15, the display panel 13 and the optical receiving device 11 are disposed from bottom to top in that order, and are substantially parallel to each other. The display panel 13 displays images, and may be a spontaneous light-emitting display panel, such as an organic light-emitting diode display panel, for example. The display panel 13 includes a display surface 131, and a back surface 133 opposite to the display surface 131. The optical receiving device 11 is disposed adjacent and parallel to the display surface 131, and the optical emitting device 15 is disposed adjacent and parallel to the back surface 133. In a typical embodiment, the display surface 131 functions as a display screen of the display device 1.

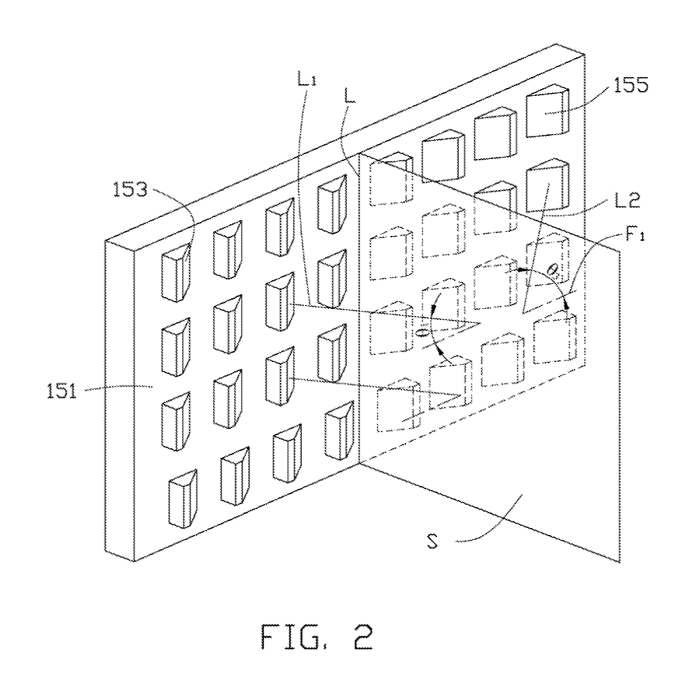

FIG. 2 is an isometric view of the optical emitting device 15. The optical emitting device 15 includes a substrate 151, a plurality of first light emitters 153, and a plurality of second light emitters 155. The first light emitters 153 and the second light emitters 155 emit invisible light, and may be infrared emitters. The substrate 151 may be made of an opaque material. The substrate 151 is divided into two symmetrical half portions (not labeled) along a median line L. The first light emitters 153 and the second light emitters 155 are respectively uniformly disposed at the two symmetrical half portions, and are arrayed symmetrically relative to the median line L. The first light emitters 153 emit a plurality of first light beams L₁ parallel to each other along a first transmission direction, and the second light emitters 155 emit a plurality of second light beams L₂ parallel to each other along a second transmission direction, and the first transmission direction and the second transmission direction converge.

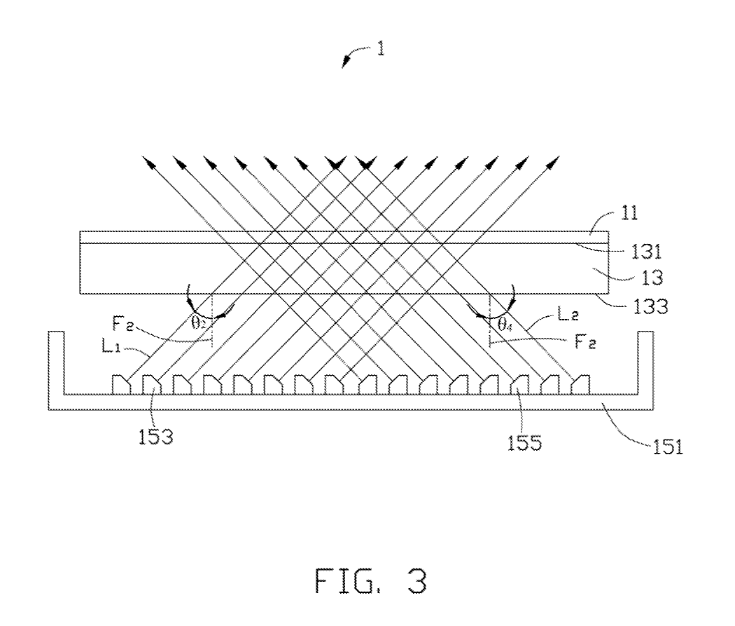

For better description, a fictional reference plane S is defined. The reference plane S perpendicularly intersects a surface of the substrate 151 at the median line L. The first light beams L₁ and the second light beams L₂ obliquely transmit towards the back surface 133 of the display panel 13. Referring also to FIG. 3, each of the first light beams L₁ has a first incident angle θ₁ with respect to a normal line F₁ of the reference plane S, and has a second incident angle θ₂ with respect to a normal line F₂ of the back surface 133. Each of the second light beams L₂ has a third incident angle θ₃ with respect to the normal line F₁ of the reference plane S, and has a fourth incident angle θ₄ with respect to the normal line F₂ of the back surface 133. The first incident angle θ₁, the second incident angle θ₂, the third incident angle θ₃, and the fourth incident angle θ₄ are acute angles. The first incident angle θ₁ is equal to the third incident angle θ₃, and the second incident angle θ₂ is equal to the fourth incident angle θ₄. Projection lines of the first light beams L₁ on the surface of the substrate 151 are parallel to or overlap projection lines of the second light beams L₂ on the surface of the substrate 151. In addition, the projection lines of the first light beams L₁ and the second light beams L₂ are all perpendicular to the median line L.

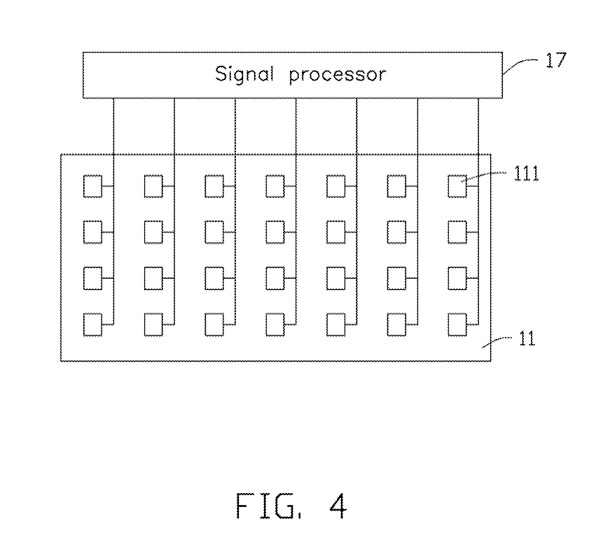

The display device 1 further includes a signal processor 17. The signal processor 17 may be formed on a substrate (not shown) of the display panel 13 together with driver components, for example. FIG. 4 is a circuit diagram of the optical receiving device 11 and the signal processor 17. The optical receiving device 11 includes a plurality of light receivers 111 disposed corresponding to the first light emitters 153 and the second light emitters 155. The light receivers 111 may be light sensors, and are electrically connected to the signal processor 17. The light receivers 111 receive the first light beams L₁ and the second light beams L₂, detect intensities of the first light beams L₁ and the second light beams L₂, transform the detected intensities to electronic signals, and provide the electronic signals to the signal processor 17.

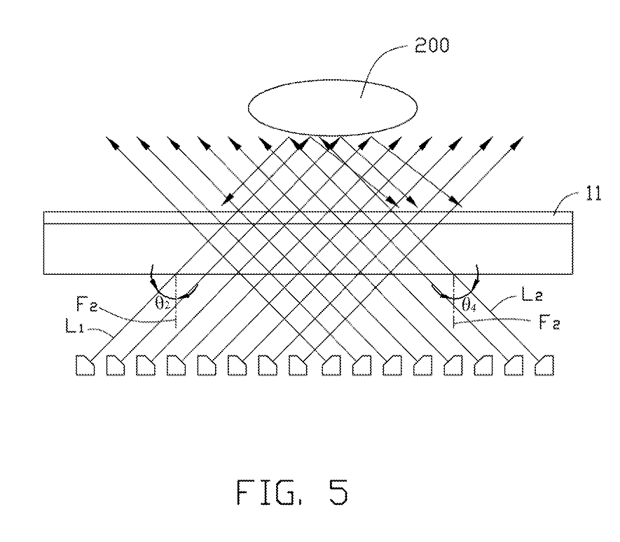

FIG. 5 is similar to FIG. 3, but also showing a directing object 200 above a light-emitting surface (not labeled) of the display device 1. The directing object 200 is an instrument for inputting a user's instruction to the display device 1, and may be a fingertip of the user or a stylus, which can reflect the light emitted from the light-emitting surface of the display device 1. Referring back to FIG. 3, when the directing object 200 is not above the light-emitting surface of the display device 1, the first light beams L₁ and the second light beams L₂ are emitted out of the light-emitting surface, and the light receivers 111 each receive the respective light beams L₁ or L₂ having corresponding intensities. When the directing object 200 is above the light-emitting surface within a predetermined range of heights above the light-emitting surface and points to a certain position of the light-emitting surface, some light beams of first light beams L₁ or the second light beams L₂ or both are reflected by the directing object 200 and received by some light receivers 111. Therefore, the intensities of the light beams received by these light receivers 111 are changed. The signal processor 17 determines which light receivers 111 receive more light beams according to the electronic signals provided by the light receivers 111, and further determines where the position of the light-emitting surface pointed to is according to the positions of the light receivers 111 receiving more light beams. After the position of the light-emitting surface pointed to is determined, the display device 1 performs a corresponding operation.

The predetermined range of heights above the light-emitting surface depends on the incident angles of the light beams emitted by the first and second light emitters 153, 155, and can be adjusted by adjusting the incident angles of the light beams emitted by the first and second light emitters 153, 155.

Therefore, the display device 1 does not need the directing object 200 to directly touch the light-emitting surface. Rather, the display device 1 merely requires that the directing object 200 is within the predetermined range of heights above the light-emitting surface, and points to any position of the light-emitting surface. Thereby, the display device 1 can perform operations corresponding to the positions of the light-emitting surface pointed to. Thus, the light-emitting surface of the display device 1 avoids contact-related contamination and damage, and a reliability of the display device 1 is improved.

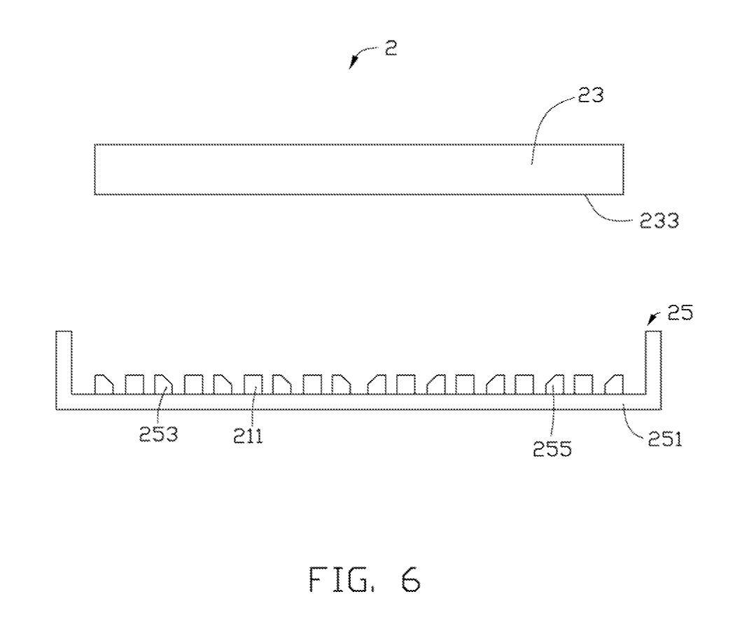

FIG. 6 is an exploded, side cross-sectional view of a display device 2 according to a second embodiment. The display device 2 is similar to the display device 1. However, the main differences between the display device 2 and the display device 1 are as follows.

In the display device 2, an optical emitting device and an optical receiving device are integrated into a one-piece structure 25, and the one-piece structure 25 is disposed adjacent to a back surface 233 of a display panel 23. In particular, a plurality of first light emitters 253 and a plurality of second light emitters 255 are respectively uniformly disposed at two symmetrical half portions of a substrate 251 of the one-piece structure 25, and a plurality of light receivers 211 are uniformly disposed at intervals with the first light emitters 253 and the second light emitters 255 in the corresponding half portions.

Because the first light emitters 253, the second light emitters 255, and the light receivers 211 are all disposed in the one-piece structure 25, a thickness of the display device 2 is less than that of the display device 1. Furthermore, because there is no optical receiving device disposed adjacent to a display surface of the display panel 23, a display brightness is increased, and a display quality of the display device 2 is accordingly improved.

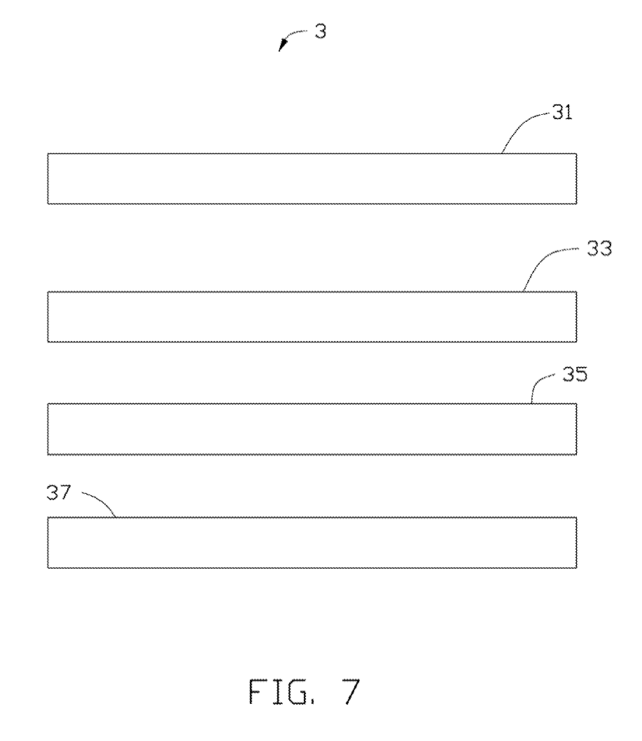

FIG. 7 is an exploded, side plan view of a display device 3 according to a third embodiment. The display device 3 is similar to the display device 1. However, the main differences between the display device 3 and the display device 1 are as follows.

The display device 3 further includes a backlight module 37. The backlight module 37 may be a direct type backlight module, which provides planer visible light to a display panel 33 for displaying images. The display panel 33 may be a liquid crystal display panel. An optical emitting device 35 is disposed between the backlight module 37 and the display panel 33, and an optical receiving device 31 is disposed adjacent to a display surface (not labeled) of the display panel 33. That is, the backlight module 37, the optical emitting device 35, the display panel 33 and the optical receiving device 31 are disposed from bottom to top in that order. A substrate (not shown) of the optical emitting device 35 should be made of transparent material in this embodiment.

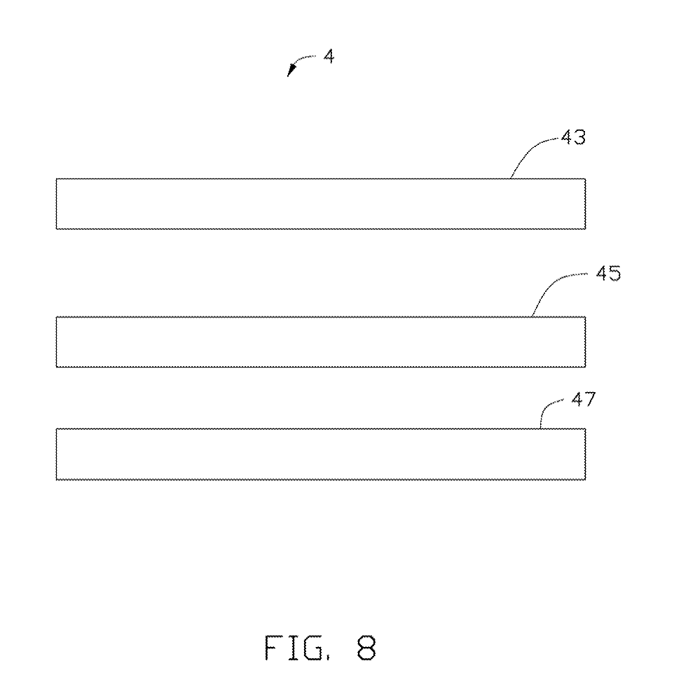

FIG. 8 is an exploded, side plan view of a display device 4 according to a fourth embodiment. The display device 4 is similar to the display device 2. However, the main differences between the display device 4 and the display device 2 are as follows.

The display device 4 further includes a backlight module 47. The backlight module 47 may be a direct type backlight module, which provides planer visible light to a display panel 43 for displaying images. The display panel 43 may be a liquid crystal display panel. A one-piece structure 45 is disposed between the backlight module 47 and the display panel 43. That is, the backlight module 47, the one-piece structure 45 and the display panel 43 are disposed from bottom to top in that order. A substrate (not shown) of the one-piece structure 45 should be made of a transparent material in this embodiment.

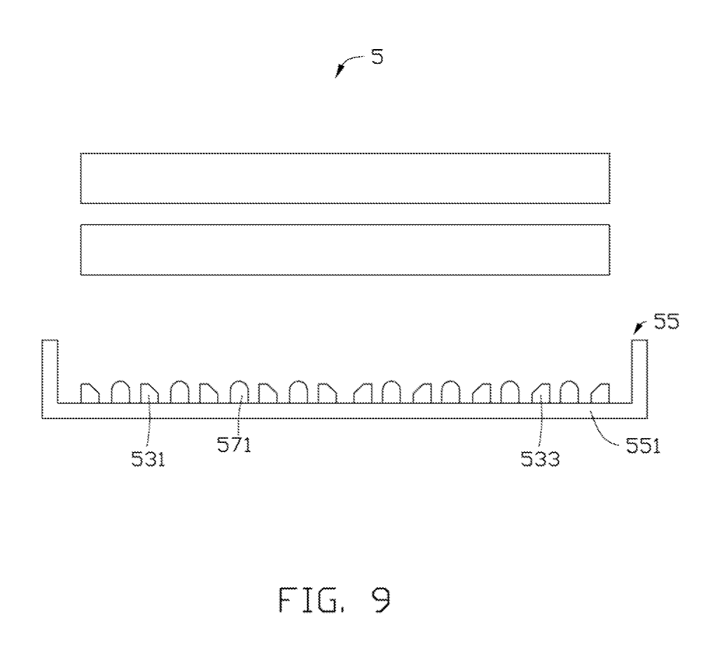

FIG. 9 is an exploded, side cross-sectional view of a display device 5 according to a fifth embodiment. The display device 5 is similar to the display device 3. However, the main differences between the display device 5 and the display device 3 are as follows.

In the display device 5, an optical emitting device and a backlight module are integrated into a one-piece structure 55. In particular, a plurality of first light emitters 531 and a plurality of second light emitters 533 are respectively uniformly disposed at two symmetrical half portions of a substrate 551 of the one-piece structure 55, and a plurality of light sources 571 are uniformly disposed at intervals with the first light emitters 531 and the second light emitters 533 in the corresponding half portions. The light sources 571 emit visible light.

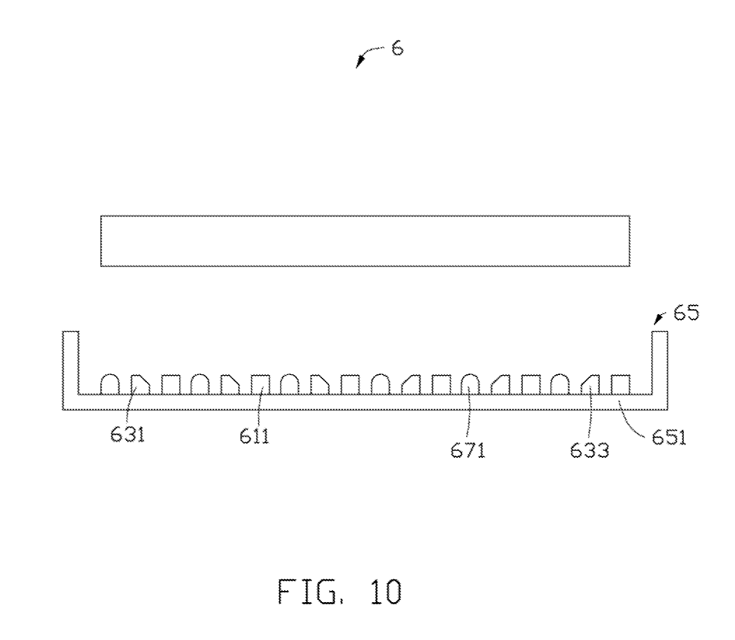

FIG. 10 is an exploded, side cross-sectional view of a display device 6 according to a sixth embodiment. The display device 6 is similar to the display device 3. However, the main differences between the display device 6 and the display device 3 are as follows.

In the display device 6, an optical emitting device, an optical receiving device and a backlight module are integrated into a one-piece structure 65. In particular, a plurality first light emitters 631 and a plurality of second light emitters 633 are respectively uniformly disposed at two symmetrical half portions of a substrate 651 of the one-piece structure 65, a plurality of light receivers 611 are uniformly disposed at intervals with the first light emitters 631 and the second light emitters 633 in the corresponding half portions, and a plurality of light sources 671 are uniformly disposed at intervals with the first light emitters 631 and the second light emitters 633 in the corresponding half portions. The light sources 671 emit visible light.

It is believed that the present embodiments and their advantages will be understood from the foregoing description, and it will be apparent that various changes may be made thereto without departing from the spirit and scope of the embodiments or sacrificing all of their material advantages.

What is claimed is:

1. A display device, comprising:
a display panel configured to display images, and comprising a display surface and a back surface opposite to the display surface;
a plurality of first light emitters and a plurality of second light emitters disposed adjacent to the back surface of the display panel and configured to emit invisible light beams to pass through the display panel; and
a plurality of light receivers disposed corresponding to the first and second light emitters and configured to receive the light beams emitted by the first and second light emitters;
wherein the plurality of first light emitters and the plurality of second light emitters are uniformly disposed to correspond to two half portions of the back surface of the display panel, respectively, and are arrayed symmetrically relative to each other, the light beams emitted by the first light emitters are parallel to each other and are obliquely emitted towards the back surface of the display panel along a first transmission direction, the light beams emitted by the second light emitters are parallel to each other and are obliquely emitted towards the back surface of the display panel along a second transmission direction, and the first transmission direction and the second transmission direction converge.

2. The display device of claim 1, wherein the light beams emitted by the first light emitters have a first incident angle relative to the back surface of the display panel, the light beams emitted by the second light emitters have a second incident angle relative to the back surface of the display panel, and the first incident angle and the second incident angle are acute angles.

3. The display device of claim 2, wherein the first incident angle is equal to the second incident angle.

4. The display device of claim 2, wherein when a directing object is positioned adjacent to a light-emitting surface of the display device within a predetermined range of heights above the light-emitting surface and points to a certain position of the light-emitting surface and reflects part of the light beams emitted by either or both of the first and second light emitters, one or more light receivers of the plurality of light receivers receive the reflected part of the light beams.

5. The display device of claim 4, further comprising a signal processor electrically connected to the light receivers, wherein the plurality of light receivers is further configured to transform the received light beams emitted by the first and second light emitters and the received reflected part of the light beams to electronic signals and provide the electronic signals to the signal processor; and the signal processor is configured to determine which light receivers of the plurality of light receivers are receiving light beams reflected by the directing object according to the electronic signals, and to further determine where the certain position pointed to is according to the positions of the light receivers receiving light beams reflected by the directing object.

6. The display device of claim 2, further comprising a substrate, wherein the first and second light emitters are respectively disposed on two half portions of a surface of the substrate, the surface of the substrate being adjacent to and parallel to the back surface of the display panel.

7. The display device of claim 6, wherein the light receivers are disposed adjacent to the display surface of the display panel.

8. The display device of claim 6, wherein the light receivers are uniformly disposed at intervals with the first light emitters and the second light emitters on the corresponding half portions of the surface of the substrate.

9. The display device of claim 6, further comprising a plurality of light sources configured to provide visible light beams to the display panel for displaying images, wherein the light sources and the light receivers are uniformly disposed at intervals with the first light emitters and the second light emitters on the corresponding half portions of the surface of the substrate.

10. The display device of claim 6, further comprising a plurality of light sources configured to provide visible light beams to the display panel for displaying images, wherein the light sources are uniformly disposed at intervals with the first light emitters and the second light emitters on the corresponding half portions of the surface of the substrate.

11. The display device of claim 7, further comprising a backlight module configured to provide visible light beams to the display panel for displaying images, wherein the substrate with the first and second light emitters is disposed between the display panel and the backlight module.

12. The display device of claim 8, further comprising a backlight module configured to provide visible light beams to the display panel for displaying images, wherein the substrate with the first and second light emitters and the light receivers is disposed between the display panel and the backlight module.

13. The display device of claim 8, wherein the first and second light emitters are infrared emitters.

14. A display device, comprising:
a display panel configured to display images, and comprising a display surface and a back surface opposite to the display surface;
a substrate adjacent to the back surface of the display panel;
a plurality of first light emitters and a plurality of second light emitters disposed on a surface of the substrate adjacent to and parallel to the back surface of the display panel, the first light emitters being configured to emit first light beams to pass through the display panel, the second light emitters being configured to emit second light beams to pass through the display panel, and the first light beams and the second light beams being invisible light beams; and
a plurality of light receivers disposed corresponding to the first and second light emitters and configured to receive the first and second light beams;
wherein the plurality of first light emitters and the plurality of second light emitters are uniformly disposed on two half portions of the surface of the substrate, respectively, and are arrayed symmetrically relative to each other, the first light beams are parallel to each other and are obliquely emitted towards the back surface of the display panel along a first transmission direction, the second light beams are parallel to each other and are obliquely emitted towards the back surface of the display panel along a second transmission direction, and the first transmission direction and the second transmission direction converge.

15. The display device of claim 14, wherein the first light beams have a first incident angle relative to the back surface of the display panel, the second light beams have a second incident angle relative to the back surface of the display panel, and the first incident angle and the second incident angle are acute angles.

16. The display device of claim 15, wherein the first incident angle is equal to the second incident angle.

17. The display device of claim 15, wherein projection lines of the first light beams on the surface of the substrate overlap corresponding projection lines of the second light beams on the surface of the substrate.

18. The display device of claim 17, wherein the half portions of the surface of the substrate are divided by a median line, and the projection lines of the first and second light beams on the surface of the substrate are perpendicular to the median line.

19. The display device of claim 15, wherein when a directing object is positioned adjacent to a light-emitting surface of the display device within a predetermined range of heights above the light-emitting surface and points to a certain position of the light-emitting surface and reflects part of the light beams emitted by either or both of the first and second light emitters, one or more light receivers of the plurality of light receivers receive the reflected part of the light beams.

20. The display device of claim 19, further comprising a signal processor electrically connected to the light receivers, wherein the plurality of light receivers is further configured to transform the received light beams emitted by the first and second light emitters and the received reflected part of the light beams to electronic signals and provide the electronic signals to the signal processor; and the signal processor is configured to determine which light receivers of the plurality of light receivers are receiving light beams reflected by the directing object according to the electronic signals, and to further determine where the certain position pointed to is according to the positions of the light receivers receiving light beams reflected by the directing object.
